(19) United States
(12) Patent Application Publication
(10) Pub. No.: US 2026/0230944 A1
(43) Pub. Date: Aug. 6, 2026

(54) METHOD AND APPARATUS FOR HANDLING HANDOVER AND LOWER LAYER TRIGGERED MOBILITY IN COMMUNICATION SYSTEM

(71) Applicant: Samsung Electronics Co., Ltd., Suwon-si, Gyeonggi-do (KR)

(72) Inventors: Aby Kanneath ABRAHAM, Bangalore (IN); Seungri JIN, Suwon-si (KR)

(21) Appl. No.: 19/154,339

(22) PCT Filed: Feb. 6, 2024
(86) PCT No.: PCT/KR2024/001727

§ 371 Date: Aug. 6, 2025

(30) Foreign Application Priority Data
Feb. 8, 2023 (IN) 202341008153
Jan. 14, 2024 (IN) 202341008153

(51) Int. Cl. H04W 36/00; H04W 36/04

(52) U.S. Cl. CPC H04W 36/0033; H04W 36/0016; H04W 36/04

(57) ABSTRACT

The disclosure relates to a 5G or 6G communication system for supporting a higher data transmission rate. A method performed by a first network node in a communication system is provided. The method includes receiving, from a second network node, a user equipment (UE) context modification request message for mobility; and in case that the first network node is not able to accept the UE context modification request message for mobility as an L1/L2 triggered mobility (LTM) command has been triggered to a UE, transmitting, to the second network node, a UE context modification failure message.

### TECHNICAL FIELD

The present invention generally relates to wireless communication networking and more particularly relates to a method and an apparatus for handling handover and Lower layer Triggered Mobility (LTM) in a communication system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIOT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also fullduplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

In wireless technologies such as Fifth Generation (5G) New Radio (NR) technologies, mobility for devices, such as User Equipment (UEs), is achieved through a process known as cell reselection in an RRC_IDLE mode. Prior to NR R17, the mobility was performed using a procedure called handover in an RRC_CONNECTED mode. Network-controlled mobility is applicable to the UEs in the RRC_CONNECTED mode and requires explicit radio resource control (RRC) signaling to be triggered by a gNB in the NR. Handover in the NR typically involves three steps: handover preparation, execution, and completion. The gNB may configure the UE to report measurements and perform handover based on the reported measurements or its own understanding of the network topology. Alternatively, the gNB may configure the UE with execution conditions for triggering handover, and once the conditions are met, the UE may move to the target cell and send a RRC Reconfiguration complete message. The 3GPP has also introduced a new handover called Dual Active Protocol Stack (DAPS) handover in release 16. However, these methods require the UE to send layer 3 (RRC) messages, leading to significant signaling overhead and latency issues. All these may be classified as L3 handover or L3 mobility.

The 3GPP release 18 is currently exploring L1/L2 Triggered Mobility (LTM), also known as Lower Layer Triggered Mobility, as a means to address issues related to latency, signalling overhead, and other concerns associated with layer 3 mobility. LTM aims to facilitate a change of serving cell via L1/L2 signalling, thereby reducing latency overhead and interruption time. To this end, a network (such as a gNB) may configure a UE with multiple candidate cells, allowing for rapid application of configurations. The network may also send Medium Access Control (MAC) Control Element (CE) or L1 signalling to dynamically switch the UE from the source cell to one of the configured candidate cells. MAC CE used to switch the UE may be known as cell switch command. The term “cell switch command” can be also referred to the term “LTM command” in the disclosure. The change of serving cell via the cell switch command may be called LTM cell switch. Importantly, the LTM can be triggered based on L1 measurements, rather than L3 measurements. It is also possible that the UE performs LTM cell switch to a LTM candidate cell after a radio link failure without an explicit cell switch command when it is configured to do so. The embodiments of the invention are equally applicable for any methods of the LTM cell switch.

The 3GPP suggests executing the LTM without resetting lower layers, such as MAC, to prevent data loss and minimize the delay in data retrieval, wherever feasible.

The gNB has the capability to furnish a LTMCandidateConfiguration. This entails the configuration of LTM candidate cells through a single RRC Reconfiguration message for a candidate target cell, or via a CellGroupConfig for each candidate target cell, or by means of any analogous RRC structure or information element (IE) that contains similar fields. An example of such an IE is the newly defined LTMCandidateConfig, which is an ASN1 sequence comprising CellGroupConfig and other pertinent information elements in the RRCReconfiguration. Moreover, the gNB is empowered to release or modify the candidate configurations. The UE can retain the LTM configuration of other candidate cells even after transitioning to a candidate cell through the LTM. Additionally, the gNB can provide the UE with the necessary configuration for conducting LTM measurements for various candidate frequencies and candidate cells, and Further reporting based on the performed LTM measurements.

The above information is presented as background information only to help the reader to understand the present invention. Applicants have made no determination and make no assertion as to whether any of the above might be applicable as prior art with regard to the present application.

### DISCLOSURE OF INVENTION

### Technical Problem

The principal object of the embodiments herein is to handle a L3 handover and a LTM handover in a telecommunication network.

Another object of the embodiments herein is to provide a gNB DU that prioritises layer 3 handover in an event when a cell switch has already been triggered.

Another object of the embodiments herein is to provide the gNB DU that transmits an F1AP UE context modification failure along with a radio network cause value that indicates the activation of LTM upon receipt of an F1AP UE context modification request for triggering reconfiguration with sync, if the cell switch has already been triggered.

Another object of the embodiments herein is to provide the gNB DU capable of communicating a failure in modifying a UE context to the network apparatus's CU upon activation of the cell switch command by the DU for the UE.

Another object of the embodiments herein is to provide the gNB DU that stops a LTM related operation for the UE by the DU, when the cell switch command is not triggered for the UE by the DU.

Another object of the embodiments herein is to provide the UE that capable of performing an early handover triggered by a Layer 3 (L3) Handover (HO) and LTM.

Another object of the embodiments herein is to provide the UE that prioritizes the LTM handover over the L3 handover, in instances where both the L3 handover command and the cell switch command for the LTM handover are received simultaneously.

Another object of the embodiments herein is to provide the UE that performs the LTM handover in the event that the L3 handover directive is received prior to the cell switch command.

Another object of the embodiments herein is to provide the UE with the capability to execute the Layer 3 (L3) handover upon receipt of the L3 handover command, even if the cell switch command for performing the LTM handover has not yet been received.

Another object of the embodiments herein is to provide the UE with the ability to receive both a cell switch command and an L3 handover command within the same transport block, in the event that both commands are received simultaneously.

### Solution to Problem

In an embodiment, a method performed by a first network node in a communication system is provided. The method includes receiving, from a second network node, a user equipment (UE) context modification request message for mobility; and in case that the first network node is not able to accept the UE context modification request message for mobility as an L1/L2 triggered mobility (LTM) command has been triggered to a UE, transmitting, to the second network node, a UE context modification failure message.

In an embodiment, a method performed by a second network node in a communication system is provided. The method includes transmitting, to a first network node, a UE context modification request message for mobility; receiving, from the first network node, a UE context modification failure message; and identifying, based on the UE context modification failure message, that the first network node is not able to accept the UE context modification request message for mobility as an LTM command has been triggered to a UE.

In an embodiment, a first network node in a communication system is provided. The first network node includes a transceiver and a controller. The controller is configured to receive, from a second network node via the transceiver, a UE context modification request message for mobility, and in case that the first network node is not able to accept the UE context modification request message for mobility as an LTM command has been triggered to a UE, transmit, to the second network node via the transceiver, a UE context modification failure message.

In an embodiment, a second network node in a communication system is provided. The second network node includes a transceiver and a controller. The controller is configured to transmit, to a first network node via the transceiver, a UE context modification request message for mobility, receive, from the first network node via the transceiver, a UE context modification failure message, and identify, based on the UE context modification failure message, that the first network node is not able to accept the UE context modification request message for mobility as an LTM command has been triggered to a UE.

In an aspect, the objects are achieved by providing a method for handling layer three (L3) handover and LTM handover in a telecommunication network. The method includes receiving, by a DU of a network apparatus, a UE context modification request from a CU of the network apparatus for the L3 handover for a UE. Further, the method includes determining, by the DU of the network apparatus, whether a cell switch command for the UE is triggered by the DU. In an embodiment, the method includes transmitting a UE context modification failure to the CU of the network apparatus, when the cell switch command is triggered for the UE by the DU. In another embodiment, the method includes stopping the LTM related operation for the UE by the DU, when the cell switch command is not triggered for the UE by the DU.

In an embodiment, the UE context modification failure is transmitted including a radio network layer cause information element (IE) in a F1AP UE context Modification Failure message.

In an embodiment, the radio network layer cause information element (IE) indicates that the lower layer mobility is already triggered.

In an embodiment, the DU identifies that the F1AP UE context Modification is for L3 handover when the F1AP UE context Modification includes SpCellId IE.

In an embodiment, the LTM related operation comprises at least one of: triggering an aperiodic downlink control information (DCI), handling of LTM measurements, triggering LTM cell switch, and sending of a random access response for LTM completion, when a source DU and a target DU are the same.

In an aspect, the objects are achieved by providing a method for handling L3 handover and LTM handover in a telecommunication network. The method includes receiving, by a UE, a L3 handover command to perform the L3 handover from a CU of a network apparatus. Further, the method includes receiving, by the UE, a cell switch command to perform the LTM handover from a DU of the network apparatus. Further, the method includes determining, by the UE, whether the L3 handover command to perform the L3 handover and the cell switch command to perform the LTM handover are received at same time or different time. In an embodiment, the method includes prioritizing the LTM handover over the L3 handover when both the L3 handover command to perform the L3 handover and the cell switch command to perform the LTM handover are received at the same time. In another embodiment, the method includes performing the LTM handover when the L3 handover command to perform the L3 handover is received before the cell switch command. In another embodiment, the method includes performing the L3 handover when the L3 handover command to perform the L3 handover is received before the cell switch command to perform the LTM handover.

In an embodiment, performing one of the LTM handover and the L3 handover when the L3 handover command to perform the L3 handover and the cell switch command to perform the LTM handover includes determining, by the UE, whether the L3 handover command is received earlier than the cell switch command, and performing, by the UE, one of: the L3 handover command over the cell switch command when the L3 handover command is received earlier than the cell switch command, and the cell switch command over a L3 handover command when the L3 handover command is received later than the cell switch command.

In an embodiment, the UE receives the cell switch command and the L3 handover command in same transport block when the cell switch command and the L3 handover command are received at the same time.

### Advantageous Effects of Invention

In an aspect, the objects are achieved by providing a DU of a network apparatus for handling L3 handover and LTM handover in a telecommunication network. The DU includes a handover co-existence controller coupled to a memory and a processor. The handover co-existence controller is configured to receive a UE context modification request from a CU of the network apparatus for the L3 handover for a UE. Further, the handover co-existence controller is configured to determine whether a cell switch command for the UE is triggered by the DU. In an embodiment, the handover coexistence controller is configured to transmit a UE context modification failure to the CU of the network apparatus, when the cell switch command is triggered for the UE by the DU. In another embodiment, the handover co-existence controller is configured to stop the LTM related operation for the UE by the DU, when the cell switch command is not triggered for the UE by the DU.

In an aspect, the objects are achieved by providing a UE for handling L3 handover and LTM handover in a telecommunication network. The UE includes a handover coexistence controller coupled to a memory and a processor. The handover co-existence controller is configured to receive a L3 handover command to perform the L3 handover from a CU of a network apparatus. Further, the handover co-existence controller is configured to receive a cell switch command to perform the LTM handover from a DU of the network apparatus. The handover co-existence controller is configured to determine whether the L3 handover command to perform the L3 handover and the cell switch command to perform the LTM handover are received at same time or different time. In an embodiment, the handover co-existence controller is configured to prioritize the LTM handover over the L3 handover when both the L3 handover command to perform the L3 handover and the cell switch command to perform the LTM handover are received at the same time. In another embodiment, the handover co-existence controller is configured to perform the LTM handover when the L3 handover command to perform the L3 handover is received before the cell switch command. In another embodiment, the handover co-existence controller is configured to perform the L3 handover when the L3 handover command to perform the L3 handover is received before the cell switch command to perform the LTM handover.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the scope thereof, and the embodiments herein include all such modifications.

### BRIEF DESCRIPTION OF DRAWINGS

These and other features, aspects, and advantages of the present invention will become better understood when the following detailed description is read with reference to the accompanying drawings in which like characters represent like parts throughout the drawings, wherein:

FIG. 1 illustrates a block diagram of an NG-RAN Overall architecture.

FIG. 2 illustrates a sequence diagram of an Intra-gNB-Inter-DU Mobility for intraNR.

FIG. 3A illustrates a sequence diagram of Intra-AMF/UPF Inter-gNB Handover.

FIG. 3B illustrates a sequence diagram of Intra-AMF/UPF Inter-gNB Handover.

FIG. 4 illustrates a telecommunication network for handling L3 handover and LTM handover, according to the embodiments as disclosed herein.

FIG. 5 illustrates various hardware components of a UE, according to the embodiments as disclosed herein.

FIG. 6 illustrates various hardware components of a DU, according to the embodiments as disclosed herein.

FIG. 7 illustrates a flow chart of a method, implemented by the UE, for handling the L3 handover and the LTM handover in the telecommunication network, according to the embodiments disclosed herein.

FIG. 8 illustrates a flow chart of a method, implemented by the DU, for handling the L3 handover and the LTM handover in the telecommunication network, according to the embodiments disclosed herein.

FIG. 9 illustrates a flow chart of a LTM handling at the DU, according to the embodiments disclosed herein.

FIG. 10 illustrates a flow chart of a LTM and L3 HO handling at a CU, according to the embodiments disclosed herein.

FIG. 11 illustrates a flow chart of a L3 HO applying part of candidate cell configuration, according to the embodiments disclosed herein.

FIG. 12 illustrates a first network node according to embodiments of the present disclosure.

FIG. 13 illustrates a second network node according to embodiments of the present disclosure.

Further, skilled artisans will appreciate that elements in the drawings are illustrated for simplicity and may not have been necessarily drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having the benefit of the description herein.

### MODE FOR THE INVENTION

Various embodiments of the present disclosure will now be described in detail with reference to the accompanying drawings. In the following description, specific details such as detailed configuration and components are merely provided to assist the overall understanding of these embodiments of the present disclosure. Therefore, it should be apparent to those skilled in the art that various changes and modifications of the embodiments described herein can be made without departing from the scope of the present disclosure. In addition, descriptions of well-known functions and constructions are omitted for clarity and conciseness.

Also, the various embodiments described herein are not necessarily mutually exclusive, as some embodiments can be combined with one or more other embodiments to form new embodiments.

Herein, the term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

In the present patent disclosure, the phrases “handover” and “conditional handover (CHO)” pertain to layer 3 mobility, encompassing PSCellChange or Conditional PSCellChange in the context of dual connectivity. The term “handover” is typically utilized to denote L3 mobility throughout the description.

Within the context of this description, it is worth noting that the designations “gNB” and “NR UE” are merely illustrative, and the embodiments discussed herein are equally applicable to technologies beyond 6G. In other words, the gNB may represent any type of network node, while the UE can pertain to any technology.

Embodiments disclosed herein provide a method for handling a L3 handover and a LTM handover in a telecommunication network. The method includes receiving, by a DU of a network apparatus, a UE context modification request from a CU of the network apparatus for the L3 handover for a UE. Further, the method includes determining, by the DU of the network apparatus, whether a cell switch command for the UE is triggered by the DU. In an embodiment, the method includes transmitting a UE context modification failure to the CU of the network apparatus, when the cell switch command is triggered for the UE by the DU. In another embodiment, the method includes stopping the LTM related operation for the UE by the DU, when the cell switch command is not triggered for the UE by the DU.

The proposed solution provides a method, a network apparatus and a UE for performing co-existence and interaction of handover and Lower layer Triggered Mobility (LTM) in a telecommunication network. The proposed solution enables seamless co-existence and interaction between handover at the L3 mobility level and lower layer triggered mobility. In one embodiment, the UE is configured to perform measurements for both LTM, which are reported through CSI reports or MAC CE, and L3 mobility through measurement configuration reports. The UE sends only CSI reports and MAC CE for LTM for the candidate cells configured for LTM, and excludes L3 measurement results for the LTM candidate cells in the measurement report sent to the network. In another embodiment, the UE is configured to perform LTM without lower layer reset, such as avoiding or partially performing MAC/RLC/PDCP reset. However, it performs lower layer reset, like MAC reset, upon receiving RRC Reconfiguration for handover or on conditional handover execution. In the NR RRC Reconfiguration containing RRCReconfigurationwithSync, the UE receives the handover.

The invention pertains to the harmonious co-existence of long-term memory (LTM) and handover mechanisms, encompassing the following: a) the handling of cell switch triggers by the gNB DU upon the initiation of layer3 handover, b) the management of layer3 handover cell switch triggers by the gNB DU when the cell switch is activated, and c) the implementation of UE aspects for effectively managing the concurrency of LTM and L3 HO. The proposed solution facilitates the prioritization of layer3 handover by gNB DU in the event of a triggered cell switch. Specifically, upon receipt of an F1AP UE context modification request for reconfiguration with sync, if the cell switch has already been triggered, the gNB DU sends an F1AP UE context modification failure message, accompanied by a radio network cause value indicating that LTM has already been triggered. Further, the UE executes the earliest handover triggered by either L3 HO or LTM.

The proposed method can be used to synchronize the different types of mobility, such as L3 handover and LTM. The proposed method brings in deterministic behaviour for the mobility and reduces unnecessary signalling and implementation complexity. For example, if the DU has triggered the LTM cell switch and the CU is not aware of it, it may proceed with additional actions leading to signalling overhead over network interfaces and on the air interface. These additional actions lead to increase in implementation complexity as methods to handle concurrency and possibly un-deterministic behaviour need to be defined.

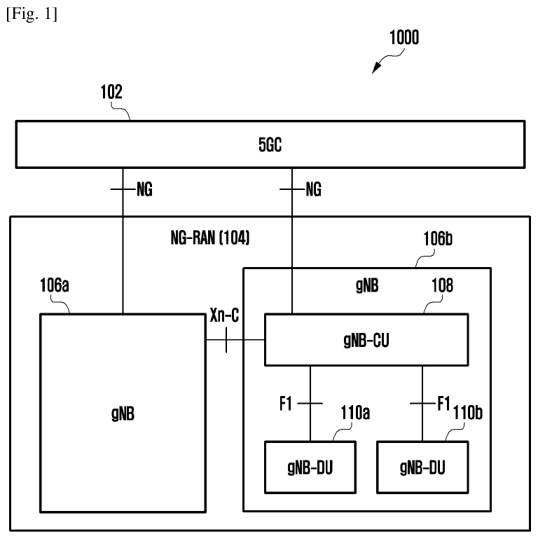

Referring now to the drawings, and more particularly to FIGS. 1 through 11, where similar reference characters denote corresponding features consistently throughout the figures, there are shown example embodiments.

FIG. 1 illustrates a block diagram of a Next Generation Radio Access Network (NG-RAN) overall architecture.

Referring to FIG. 1, the NG-RAN (104) may comprise a set of gNBs (106a and 106b) connected to a 5GC (102) through a NG interface in a telecommunication network (1000). The gNBs (106a and 106b) can be interconnected through a Xn interface. The gNB (106a and 106b) may comprise a gNodeB Centralized Unit (gNB-CU) (108) and one or more gNodeB Distributed Unit (gNB-DU) (110a and 110b). The gNB (106a and 106b)-CU and the gNB-DU (110a and 110b) are connected via F1 interface. The F1 Application Protocol (F1AP) is the protocol used for signaling via F1 interface. The F1AP provides the signalling service between the gNB-DU and the gNB-CU that is required to fulfil the F1AP functions. The Signalling services provided by F1AP may include the following:

Non UE-associated services: They are related to the whole F1 interface instance between the gNB-DU and gNB-CU utilizing a non UE-associated signalling connection.

UE-associated services: They are related to one UE. F1AP functions that provide these services are associated with a UE-associated signalling connection that is maintained for the UE in question. UE associated signaling is used to setup a UE context (using UE CONTEXT SETUP REQUEST message from CU to DU), modify a UE context (UE CONTEXT MODIFICATION REQUEST message from CU to DU) and release a UE context (UE CONTEXT RELEASE COMMAND message from CU to DU) along with other functions.

F1AP UE CONTEXT MODIFICATION REQUEST can include different fields such as SpCell ID, list of radio bearers to be setup such as the list of signaling radio bearers (SRB) or the list of data radio bearers (DRB) to be setup or released or modified, configuration for lower layer triggered mobility (LTM) etc. F1AP UE Context Modification Request also may include an RRC-Container which includes a Downlink Dedicated Control Channel (DL-DCCH message) encapsulated in a Packet Data Convergence Unit (PDCP) Protocol Data Unit (PDU).

Measurement Configuration: A NR R17 UE (202) can be configured with MeasConfig IE for performing layer 3 measurements. The MeasConfig may include the information elements as Table 1 below.

TABLE 1
MeasConfig ::= SEQUENCE {
measObjectToRemoveList MeasObjectToRemoveList OPTIONAL, -- Need N
measObjectToAddModList MeasObjectToAddModList OPTIONAL, -- Need N
reportConfigToRemoveList ReportConfigToRemoveList OPTIONAL, -- Need N
reportConfigToAddModList ReportConfigToAddModList OPTIONAL, -- Need N
measIdToRemoveList MeasIdToRemoveList OPTIONAL, -- Need N
measIdToAddModList MeasIdToAddModList OPTIONAL, -- Need N
s-MeasureConfig CHOICE {
ssb-RSRP RSRP-Range,
csi-RSRP RSRP-Range
} OPTIONAL, -- Need M
quantityConfig QuantityConfig OPTIONAL, -- Need M
measGapConfig MeasGapConfig OPTIONAL, -- Need M
measGapSharingConfig MeasGapSharingConfig OPTIONAL, -- Need M
...,
[[
interFrequencyConfig-NoGap-r16 ENUMERATED {true} OPTIONAL -- Need R
]]
}

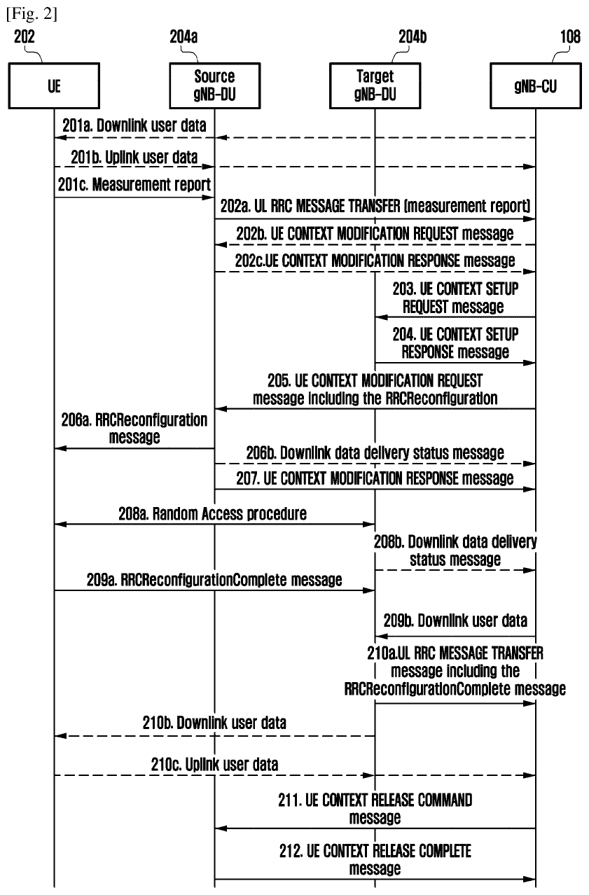

FIG. 2 illustrates a sequence diagram of an Intra-gNB-Inter-DU Mobility for intra-NR.

The Intra-gNB-Inter-DU Mobility procedure is used for the case when the UE (202) moves from one gNB-DU to another gNB-DU within the same gNB-CU (108) during a NR operation. FIG. 2 shows the inter-gNB-DU mobility procedure for the intra-NR.

At step 201a, the UE (202) receives a downlink user data from the gNB-CU (108) through a source gNB-DU (204a). At step 201b, the UE (202) sends an uplink user data to the gNB-CU (108) through the source gNB-DU (204a). At step 201c, the UE (202) sends a MeasurementReport message to the source gNB-DU (204a).

At step 202a, the source gNB-DU (204a) sends an UL RRC message transfer message to the gNB-CU (108) to convey the received MeasurementReport message. At step 202b, the gNB-CU (108) may send a UE context modification request message to the source gNB-DU (204a) to query a latest configuration. At step 202c, the source gNB-DU (204a) responds with a UE context modification response message that includes full configuration information.

At step 203, the gNB-CU (108) sends a UE context setup request message to the target gNB-DU (204b) to create a UE context and setup with one or more data bearers. The UE context setup request message includes a HandoverPreparationInformation. In case of NG-RAN sharing, the gNB-CU (108) includes a serving Public Land Mobile Network (PLMN) identifier (ID) (for Standalone Non-Public Networks (SNPNs) the serving SNPN ID).

At step20 4, the target gNB-DU (204a) responds to the gNB-CU (108) with a UE context setup response message. At step 205, the gNB-CU (108) sends a UE context modification request message to the source gNB-DU (204a), which includes a generated RRCReconfiguration message and indicates to stop the data transmission for the UE (202). The source gNB-DU (204a) also sends a downlink data delivery status frame to inform the gNB-CU (108) about the unsuccessfully transmitted downlink data to the UE (202).

In the event of a Dual Active Protocol Stack (DAPS) Handover, the modification request message for the UE context in step 205 may either direct the cessation of data transmission for a specific Data Radio Bearer (DRB) not subject to the DAPS handover or forego any instruction to stop data transmission altogether. Instead, a Downlink (DL) RRC message transfer procedure may be employed to convey the handover command to the UE (202). The UE context modification request message that signals the cessation of data transmission for the UE (202) is dispatched to the source gNB DU (204a) after the gNB-CU (108) has confirmed that the UE (202) has successfully connected to the target gNB-DU (204b). Upon receipt, the source gNBDU (204a) transmits a Dynamic Delegation Discovery System (DDDS) frame to the gNB-CU (108) regarding the downlink data that failed to transmit.

At step 206a, the source gNB-DU (204a) forwards the received RRCReconfiguration message to the UE (202). At step 206b, the source gNB-DU (204a) sends the downlink data delivery status message to the gNB-CU (108). At step 207, the source gNB-DU (204a) responds to the gNB-CU (108) with the UE context modification response message.

At step 208a, a random access procedure is performed at the target gNB-DU (204b). At step 208b, the target gNB-DU (204b) sends a Downlink Data Delivery Status frame to inform the gNB-CU (108). Downlink packets, which may include Packet Data Convergence Protocol (PDCP) PDUs not successfully transmitted in the source gNB-DU (204a), are sent from the gNB-CU (108) to the target gNB-DU (204b). Note that it is up to gNB-CU implementation whether to start sending DL User Data to the gNB-DU (110) before or after reception of the downlink data delivery status.

At step 209a, the UE (202) responds to the target gNB-DU (204b) with an RRCReconfigurationComplete message. At step 209b, the target gNB-DU (204b) receives the downlink user data from the gNB-CU (108). At step 210a, the target gNB-DU (204b) sends an UL RRC message transfer message to the gNB-CU (108) to convey the received RRCReconfigurationComplete message. At step 210b, downlink packets are sent to the UE (202). At step 210c, also, uplink packets are sent from the UE (202), which are forwarded to the gNB-CU (108) through the target gNB-DU (204b).

At step 211, the gNB-CU (108) sends a UE context release command message to the source gNB-DU (204a). At step 212, the source gNB-DU (204a) releases the UE context and responds the gNB-CU (108) with a UE context release complete message.

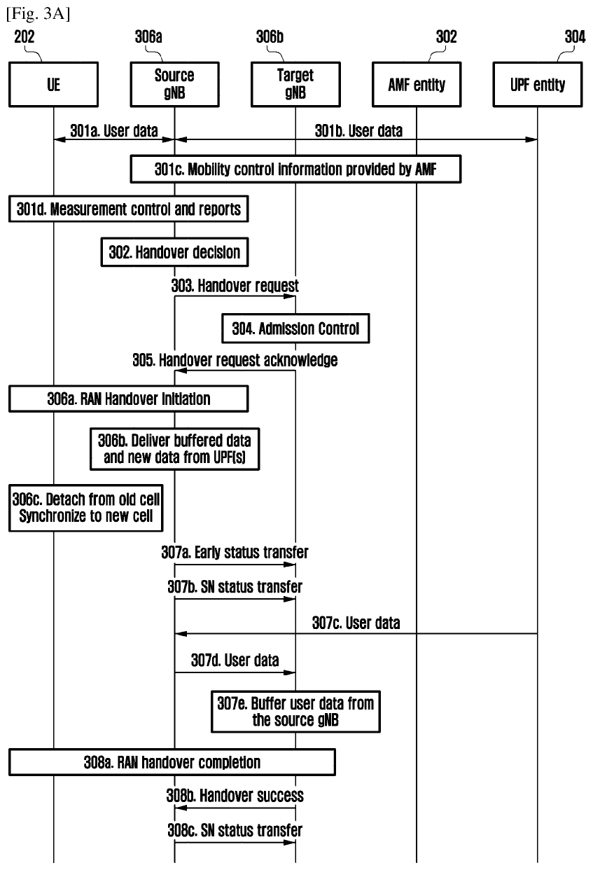

FIGS. 3A and 3B illustrate a sequence diagram of Intra-AMF/UPF Inter-gNB Handover.

Referring to FIGS. 3A and 3B, the intra-NR RAN handover performs the preparation and execution phase of the handover procedure performed without involvement of the 5GC (102), i.e. preparation messages are directly exchanged between the gNBs (106a and 106b). The release of the resources at the source gNB (204a) during the handover completion phase is triggered by the target gNB (204b). The FIG. 3A and FIG. 3B depict the basic handover scenario where neither an Access and Mobility Management Function (AMF) nor the User Plane Function (UPF) changes:

At step 301a, the user data is provided between the UE (202) and the source gNB (204a). At step 301b, the user data is provided between the UPF entity (304) and the source gNB (306). At step 301c, the mobility control information is provided by the AMF entity (302). The UE context within the source gNB (306a) contains information regarding roaming and access restrictions which were provided either at connection establishment or at the last tracking area (TA) update. At step 301d, the source gNB (306a) configures the UE measurement procedures and the UE reports according to the measurement configuration.

At step 302, the source gNB (306a) makes a decision to initiate a handover of the UE based on information gathered from the MeasurementReport and Radio Resource Management (RRM). At step 303, the source gNB (306a) issues a handover request message to the target gNB (306b), which contains a transparent RRC container that includes all the necessary information required to prepare for the handover at the target side. This information includes, but is not limited to, a target cell identifier (ID) KgNB*, a Cell Radio Network Temporary Identifier (C-RNTI) of the UE (202) in the source gNB (306a), RRM-configuration, basic AS-configuration, antenna information, downlink (DL) carrier frequency, current Quality of Service (QoS) flow to DRB mapping rules applied to the UE (202), a SIB1 from the source gNB (306a), the UE capabilities for different Radio Access Technology (RAT), Protocol Data Unit (PDU) session related information, and UE reported measurement information, including beam-related information if available. The PDU session related information also includes slice information and QoS flow level QoS profile(s). Additionally, the source gNB (306a) may request the DAPS handover for one or more DRBs. It is important to note that after issuing the handover request, the source gNB (306a) may refrain from reconfiguring the UE (202), including performing Reflective QoS flow to the DRB mapping.

At step 304, the target gNB (306b) may perform admission control. This process involves slice-aware admission control if the slice information has been transmitted to the target gNB (306b). If any of the PDU sessions are associated with non-supported slices, the target gNB (306b) rejects such PDU sessions. Moving on to step 305, the target gNB (306b) prepares the handover with L1/L2 and sends an acknowledgement of the handover request to the source gNB (306a). This acknowledgement includes a transparent container that is to be sent to the UE (202) as an RRC message to perform the handover. Additionally, the target gNB (306b) indicates whether a DAPS handover has been accepted.

Upon receipt of the handover request acknowledgement by the source gNB (306a), or upon initiation of the handover command transmission in the downlink, data forwarding may commence. For DRBs configured with the DAPS, downlink PDCP SDUs are forwarded with an SN assigned by the source gNB (306a) until the SN assignment is transferred to the target gNB (306b) in step 308b, at which point normal data forwarding resumes.

At step 306a, the source gNB (306a) initiates a Uu handover by transmitting an RRCReconfiguration message to the UE (202). This message includes vital information for accessing the target cell, such as the target cell ID, the new C-RNTI, the target gNB (306b), and security algorithm identifiers for the chosen security algorithms. Additionally, it may comprise a set of dedicated Random Access Channel (RACH) resources, the correlation between RACH resources and SSB(s), the association between RACH resources and UE-specific CSI-RS configuration(s), common RACH resources, and system information of the target cell, among other details.

In DRBs equipped with the DAPS, the source gNB (306a) continues to transmit downlink packets until it receives the HANDOVER SUCCESS message from the target gNB (306b) in step 308a. It is not possible to configure CHO simultaneously with DAPS handover.

At step 306b, the source gNB (306a) is bestowed with both the deliver buffered data and fresh data from the UPF entity (304). Further, in the 6c stage, the UE (202) disengages from the previous cell and harmonizes with the new cell.

At step 307a for DRBs that are configured with the DAPS, an early status transfer message is sent by the source gNB (306a). The conveyed DL COUNT value indicates the PDCP SN and Hyper Frame Number (HFN) of the first PDCP SDU that is forwarded to the target gNB (306b). Additionally, the source gNB (306a) continues to assign SNs to downlink PDCP SDUs until the SN STATUS TRANSFER message is sent to the target gNB (306b) during step 308b.

At step 307b, if the DRBs are not configured with the DAPS, the source gNB (306a) transmits the SN status transfer message to the target gNB (306b). This message conveys the uplink PDCP SN receiver status and the downlink PDCP SN transmitter status of DRBs for which PDCP status preservation is applicable (i.e., for RLC AM). The uplink PDCP SN receiver status comprises, at minimum, the PDCP SN of the first missing UL PDCP SDU. Additionally, it may include a bit map of the receive status of the out-of-sequence UL PDCP SDUs that the UE (202) needs to retransmit in the target cell (if any). The downlink PDCP SN transmitter status indicates the next PDCP SN that the target gNB (306b) assigns to new PDCP SDUs that do not have a PDCP SN yet.

At step 307c, the UPF entity (304) sends the user data to the source gNB (306a). At step 307d, the source gNB (306a) sends the user data to the target gNB (306b). At step 307e, the target gNB (306b) receives the buffer user data from the source gNB (306a).

In the event of a DAPS handover, the transfer of uplink PDCP SN receiver status and downlink PDCP SN transmitter status for the DRB, which is not configured with the DAPS and uses RLC-AM, may occur through the SN STATUS TRANSFER message during step 308b, rather than step 307a.

For DRBs configured with DAPS, the source gNB (306a) may additionally send the EARLY STATUS TRANSFER message(s) between step 307a and step 308b, to inform discarding of already forwarded PDCP SDUs. The target gNB (306b) does not transmit forwarded downlink PDCP SDUs to the UE (202), whose COUNT is less than the conveyed DL COUNT value and discards them if transmission has not been attempted already.

At step 308a, the UE (202) achieves synchronization with the target cell and successfully concludes the RRC handover process by transmitting the RRCReconfigurationComplete message to the target gNB (306b). In the event of a DAPS handover, the UE (202) refrains from detaching from the source cell upon receiving the RRCReconfiguration message. Instead, it releases the source resources and configurations, and ceases DL/UL transmission and reception with the source, only upon receiving an explicit release from the target node.

From the perspective of RAN, the completion of DAPS handover is contingent upon the UE (202) releasing the source cell as per the explicit request of the target node. Failure to do so will result in RRC suspending any subsequent handover or inter-RAT handover until the source cell has been released.

During the DAPS handover process, at steps 308b and 308c, the target gNB (306b) transmits a handover success message to the source gNB (306a) to indicate that the UE (202) has successfully connected to the target cell. In response, the source gNB (306a) dispatches the SN status transfer message for DRBs configured with DAPS, as described in step 307, and the data forwarding procedure is followed.

In step 308b, if configured with the DAPS, the SN STATUS TRANSFER message also communicates the status of the uplink PDCP SN receiver and the downlink PDCP SN transmitter for DRBs utilizing RLC-UM.

In DRBs that are configured with DAPS, the source gNB (306a) continues to deliver uplink QoS flows to the UPF entity (304) until it transmits the SN STATUS TRANSFER message in step 308b. Similarly, the target gNB (306b) refrains from forwarding QoS flows of the uplink PDCP SDUs successfully received in-sequence to the UPF entity (304) until it receives the SN STATUS TRANSFER message. This message contains the UL HFN and the first missing SN in the uplink PDCP SN receiver status that indicates the start of uplink PDCP SDUs to be delivered to the UPF. Furthermore, the target gNB (306b) does not deliver any uplink PDCP SDUs that have an UL COUNT lower than the provided value.

At step 309a, the user data is exchanged between the UPF entity (304) and the source gNB (306b). Moving on to step 309b, the user data is transferred between the target gNB (306b) and the source gNB (306a). At step 309c, the user data is transmitted between the UE (202) and the target gNB (306b). In step 309d, the user data is shared between the UPF entity (304) and the target gNB (306b). Further, at step 309e, the target gNB (306b) initiates a path switch request message to the AMF entity (302) to prompt 5GC (102) to shift the DL data path towards the target gNB (306b) and establish an NG-C interface instance towards it as well.

During steps 310a through 310c, the 5GC (102) expertly redirects the DL data path towards the desired gNB (306b). Further, the UPF entity (304) dutifully transmits one or more “end marker” packets on the previous path to the source gNB (306a) for each PDU session/tunnel. Following this, it may relinquish any U-plane/TNL resources towards the source gNB (306a).

At step 311, the AMF entity (302) confirms the PATH SWITCH REQUEST message by responding with the PATH SWITCH REQUEST ACKNOWLEDGE message. At step 312, upon receiving the PATH SWITCH REQUEST ACKNOWLEDGE message from the AMF entity (302), the target gNB (306b) transmits the UE context release signal to notify the source gNB (306a) of the successful handover. Further, the source gNB (306a) can release the radio and C-plane related resources linked to the UE context. Any ongoing data forwarding can continue uninterrupted.

The RRM configuration may encompass a combination of beam measurement data (pertaining to layer 3 mobility) associated with SSB(s) and CSI-RS(s) for the relevant cell(s), provided that both forms of measurements are obtainable. Additionally, if Carrier Aggregation (CA) has been implemented, the RRM configuration may comprise a roster of the most optimal cells on each frequency, for which measurement data is accessible. The RRM measurement data may also encompass beam measurements for the cells listed under the target gNB (306b).

The standard RACH configuration for the beams in the desired cell is exclusively linked to the SSB(s). However, the network equipment may possess customized RACH configurations that are linked to either the SSB(s) or CSI-RS(s) within the cell. When issuing the handover command to facilitate the UE's access to the target cell, the target gNB (306b) may select one of the available RACH configurations.

Common RACH configuration;

Common RACH configuration+Dedicated RACH configuration associated with SSB; and

Common RACH configuration+Dedicated RACH configuration associated with CSI-RS.

The RACH configuration that is allocated assigns a quality threshold to the RACH resource(s) for optimal utilization. Upon provision of the dedicated RACH resources, the UE (202) prioritizes them and refrains from switching to contention-based RACH resources as long as the quality threshold of the dedicated resources is maintained. The sequence for accessing the dedicated RACH resources is subject to the UE implementation.

Upon receipt of the handover command requesting DAPS handover, the UE (202) suspends the source cell's Signalling Radio Bearers (SRBs), ceases sending and receiving any RRC control plane signalling towards the source cell, and establishes SRBs for the target cell. Upon successful DAPS handover execution, the UE (202) releases the source cell SRBs configuration upon receiving the source cell release indication from the target cell. In the event of a failed DAPS handover to the target cell, and if the source cell link is available, the UE (202) reverts back to the source cell configuration and resumes source cell SRBs for control plane signalling transmission.

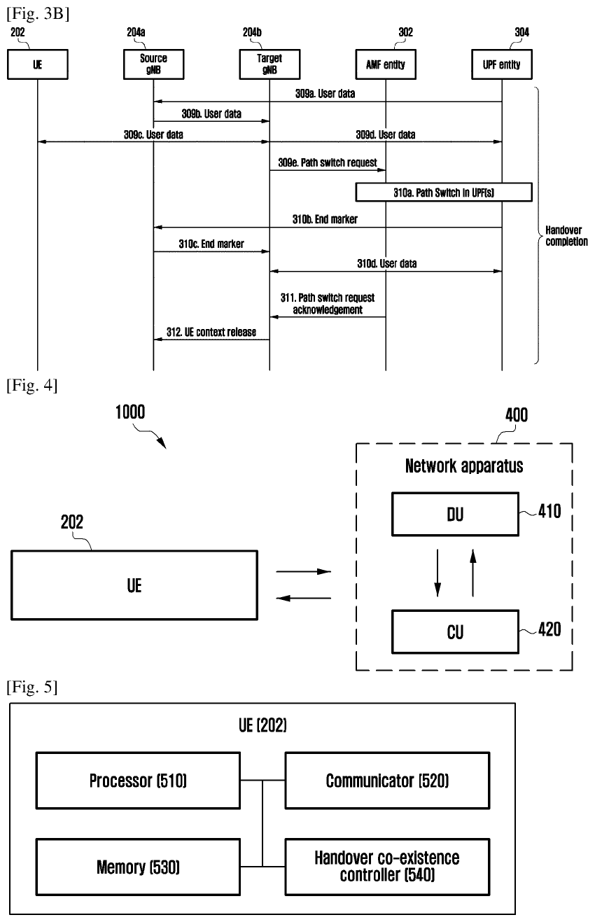

FIG. 4 illustrates a telecommunication network (1000) for handling a L3 handover and a LTM handover, according to the embodiments as disclosed herein. The telecommunication network (1000) may encompass a range of technologies, including but not limited to fourth generation (4G), fifth generation (5G), or even sixth generation (6G) networks. Additionally, it may also include an Open Radio Access Network (ORAN) or similar innovations.

In an embodiment, the telecommunication network (1000) includes a UE (202) and a network apparatus (400). In an embodiment, the network may be a base station or a gNB. In an embodiment, the network apparatus (400) includes a DU (410) and a CU (420). In another embodiment, the DU (410) and the CU (420) are placed apart from each other. The UE (202) can be, for example, but not limited to a laptop, a smart phone, a desktop computer, a notebook, a Device-to-Device (D2D) device, a vehicle to everything (V2X) device, a foldable phone, a smart TV, a tablet, an immersive device, and an internet of things (IoT) device.

The network apparatus (400) sends a UE context modification request to the DU (410) for the L3 handover of the UE (202). The DU (410) then assesses whether a cell switch command for the UE (202) has been triggered. If the DU (410) determines that a cell switch command has been triggered, it transmits a UE context modification failure to the CU (420) of the network apparatus (400), which includes a radio network layer cause IE in a F1AP UE context. The radio network layer cause IE indicates that the lower layer mobility has already been triggered. The DU (410) identifies that the F1AP UE context modification is for L3 handover when the F1AP UE context Modification includes SpCellId IE.

Further, if the DU (410) determines that a cell switch command has not been triggered, it halts the LTM related operation for the UE (202) by the DU (410). This operation could include, for example, triggering an aperiodic DCI handling of LTM measurements, triggering LTM cell switch when a source DU and a target DU are the same, and sending a random access response for LTM completion.

The embodiments presented herein are contingent upon the UE's capabilities as reported to the network apparatus (400). It is possible that certain UEs (202) may not possess the necessary capabilities. To configure the LTM, the following example sequence of Table 2 can be used.

TABLE 2
RRCReconfiguration-v18xx-Ies ::= SEQUENCE {
Ltm-Config LTM-Config OPTIONAL,
<other IEs>
}
LTM-Config ::= SEQUENCE {
candLTM-Reconfiguration SEQUENCE CandLTM Reconfiguration OPTIONAL -
Need M,
LTMMeasConfig LTMMeasConfig OPTIONAL -Need M,
nonCriticalExtension RRCReconfiguration-v1xxx-Ies
OPTIONAL,
LTMRefConfig LTMRefConfigType OPTIONAL -Need M,
}
CandLTM-Reconfiguration ::= SEQUENCE {
candLTM-ReconfigToRemoveList CandLTM-ReconfigToRemoveList OPTIONAL, -
- Need N
candLTM-ReconfigToAddModList CandLTM-ReconfigToAddModList OPTIONAL,
-- Need N
...
}
CandLTM-ToAddModList ::= SEQUENCE (SIZE (1.. maxNr)) OF CandLTM-
ToAddMod
CandLTM-ToAddMod ::= SEQUENCE {
candLTM-ReconfigId CandLTM-ReconfigId,
candLTM-Reconfig CandLTM-Reconfig,
}
CandLTM-Reconfig ::= SEQUENCE {
candLTM-CellGroupConfig CellGroupConfig,
measConfig MeasConfig OPTIONAL,
radioBearerConfig RadioBearerConfig OPTIONAL,
<other IEs>
}

The UE (202) receives LTM configuration from gNB (106a and 106b) through RRC messages. Additionally, gNB CU (108) may transmit LTM configuration, which includes LTM measurement configuration, to gNB DU (204). The LTM measurement configuration transmitted from gNB CU (108) to gNB DU (110) comprises L1 measurement configuration for LTM, measurement objects for LTM measurements (such as the frequencies and cells to be measured), measurement identifiers, measurement gap configurations, reporting configuration (including measurement filters, thresholds, and offsets), and other relevant parameters.

Measurement Reporting when Both L1 Measurements for LTM and L3 Measurements are Configured:

In an embodiment, the UE (202) configured for measurements for both LTM (reported through CSI reports or MAC CE) and L3 mobility through measurement configuration reports only CSI reports and MAC CE for the LTM for the candidate cells configured for the LTM and skips including L3 measurement results for the LTM candidate cells in the measurement report send to the network apparatus (400).

In an embodiment, the UE (202) receives an indication to skip the reporting of layer 3 measurements. (e.g. a flag skipL3Meas). The UE (202) skips reporting layer 3 measurements if the field (i.e. the above indication) is present or if the field is present and indicates to skip L3 measurements. In an embodiment, the flag skipL3meas is provided per candidate cell by the network apparatus (400) and the UE (202) doesn't report layer 3 measurements (i.e. doesn't include the measurements for those candidate cells in the measurement report) to the network apparatus (400). In an embodiment, the network apparatus (400) provides a list of candidate cells for which the UE (202) can skip L3 measurement reporting and the UE (202) doesn't report layer 3 measurements (i.e. doesn't include the measurements for those candidate cells in the measurement report) to the network apparatus (400).

In an embodiment, the UE (202) is equipped to perform measurements for both LTM via CSI reports or MAC CE, as well as L3 mobility via measurement configuration. Specifically, the UE (202) refrains from reporting CSI reports and MAC CE for LTM for candidate cells designated for LTM, and instead incorporates L3 measurement outcomes for the LTM candidate cells in the measurement report.

In an embodiment, the UE (202) is configured for measurements for both LTM (reported through CSI reports or MAC CE) and L3 mobility through measurement configuration. The UE (202) reports both CSI reports and MAC CE for LTM for the candidate cells configured for LTM and skips including L3 measurement results for the LTM candidate cells in the measurement.

### Interaction of Handover and LTM:

It is assumed that the source DU (204a) associated with the UE (202) has been configured with the LTM candidate cells and are performing the LTM measurements. The UE (202) is configured for reporting or reporting the LTM measurements (such as periodic CSI reports for LTM candidate cells, aperiodic CSI reports for LTM candidate cells, event triggered CSI reports for LTM, event triggered MAC CE reports for LTM).

In an embodiment, upon performing the L3 handover, the gNB CU (108) instructs the source gNB DU (204a) to stop performing the LTM.

In an embodiment of the L3 mobility procedure, the gNB CU (108) requests the source gNB DU (204a) to cease one or more LTM related actions, which the DU (410) then complies with. In an embodiment, the source DU halts the sending of cell switch commands to stop LTM action, while in yet another embodiment, the source DU discontinues sending triggers, such as DCI triggers for aperiodic CSI reports, and refrains from handling received LTM measurements from the UE (202). Additionally, the source DU may also skip sending random access responses for LTM completion when the source and target cells are on the same DU, among other actions.

In an embodiment, the L3 mobility procedure, the gNB CU (108) may request the source gNB DU (204a) to cease one or more LTM related actions. This can be accomplished by incorporating an information element (IE) in the F1AP UE context modification procedure.

In an embodiment, the L3 mobility procedure, the gNB CU (108) makes a request to the source gNB DU (204a) to cease one or more LTM-related actions by incorporating the IE in the F1AP UE context modification procedure, sent during step 202a as depicted in FIG. 2.

In an embodiment, the gNB-CU (108) transmits a F1AP UE context modification request message to the source gNB (106a and 106b)-DU, requesting the latest configuration as depicted in step 202a of FIG. 2. Additionally, the gNB-CU (108) provides instructions to the gNB DU (110) to cease one or more LTM actions within the same UE context modification request message.

In a different configuration, the gNB-CU (108) dispatches a message to modify the F1AP UE context to the source gNB-DU (204a). This message incorporates a generated RRCReconfiguration message and prompts the cessation of data transmission for the UE (202), as outlined in step 205 of FIG. 2. Additionally, within the same UE context modification request message, the gNB-CU (108) issues instructions to the gNB-DU (110) to discontinue one or more LTM actions.

In an embodiment, the gNB CU (108) incorporates an IE into the F1AP UE context modification request to halt one or more LTM actions. This IE is an enumerated IE, specifically the CellSwitchStop Indicator ENUMERATED {true}. Upon receipt of the F1AP UE context modification request with the aforementioned enumeration set to true, the gNB DU (110) ceases to execute one or more LTM actions. These actions may include sending a cell switch command, triggering aperiodic CSI reports, processing received LTM measurement reports (such as CSI reports for LTM or UL MAC CE for LTM measurements), or refraining from sending a random access response for LTM completion when the source and target cells are on the same DU. Alternatively, in another embodiment, the request to stop one or more LTM actions is conveyed through the existing F1AP IE “Transmission Stop Indicator.”

In an embodiment, during L3 mobility procedure, the source DU stops one or more actions for LTM. In an embodiment, the LTM action stopping is performed by the source DU stopping sending cell switch command. In an embodiment, the LTM action stopping is performed by the source DU stopping sending trigger such as DCI trigger for aperiodic CSI reports, not handling any received LTM measurements from the UE (202), stopping/skipping sending random access response for LTM completion when source and target cells are on the same DU etc. In an embodiment, if the source DU receives F1AP UE context modification request including SpCell ID IE, source DU stops LTM actions.

In an embodiment of the L3 mobility procedure, the gNB CU (108) issues instructions to the source gNB DU (110) to cease one or more LTM actions for one or more candidate cells. The gNB CU (108) maintains a list of SpCell IDs for which the gNB DU (110) suspends LTM actions. The source DU can stop LTM actions by discontinuing the transmission of cell switch commands or triggers, such as DCI triggers for aperiodic CSI reports, and by refraining from handling any received LTM measurements from the UE (202). Additionally, the source DU can skip or stop sending a random access response for LTM completion when the source and target cells are on the same DU. If the source DU receives an F1AP UE context modification request that includes an SpCell ID IE, the DU halts LTM actions.

In an embodiment, upon completion of the L3 mobility procedure, the gNB DU (110) resumes the LTM actions if the cell to which the UE (202) has been successfully handed over includes the LTM configuration for one or more candidate cells in the DU (410).

In an embodiment, if the source DU receives F1AP UE context modification request including SpCell ID IE while it has already trigged the cell switch command, the source DU sends the F1AP UE context modification failure. In an embodiment, source DU informs CU that the failure is due to lower layer mobility. In an embodiment, source DU informs CU that the failure is due to lower layer mobility is already triggered. In an embodiment, source DU informs CU that the failure is due to lower layer mobility ongoing. In an embodiment, source DU informs CU the failure as in above embodiments by setting the cause IE (radio network layer cause IE) in F1AP UE context modification failure message.

In an embodiment, if the source DU receives the F1AP UE context modification request for handover (Reconfiguration WithSync) while it has already trigged a cell switch command, the source DU sends the F1AP UE context modification failure. In an embodiment, the source DU informs CU that the failure is due to lower layer mobility. In an embodiment, source DU informs CU that the failure is due to lower layer mobility is already triggered. In an embodiment, source DU informs CU that the failure is due to lower layer mobility ongoing. In an embodiment, source DU informs CU the failure as in above embodiments by setting the cause IE (radio network layer cause IE) in F1AP UE context modification failure message.

In an embodiment, if the source DU receives F1AP UE context modification request for handover/mobility as in step 205 of FIG. 2 while it has already trigged a cell switch command, it sends F1AP UE context modification failure. In an embodiment, source DU informs CU that the failure is due to lower layer mobility. In an embodiment, source DU informs CU that the failure is due to lower layer mobility is already triggered. In an embodiment, source DU informs CU that the failure is due to lower layer mobility ongoing. In an embodiment, source DU informs CU the failure as in above embodiments by setting the cause IE (radio network layer cause IE) in F1AP UE context modification failure message. In an embodiment, the source DU sends a cell switch command/LTM command to the UE using a MAC CE.

In an embodiment, if the source DU receives F1AP UE context modification request for handover/mobility as in step 202a while it has already trigged a cell switch command, it sends F1AP UE context modification failure. In an embodiment, source DU informs CU that the failure is due to lower layer mobility. In an embodiment, source DU informs CU that the failure is due to lower layer mobility is already triggered. In an embodiment, source DU informs CU that the failure is due to lower layer mobility ongoing. In an embodiment, source DU informs CU the failure as in above embodiments by setting the cause IE (radio network layer cause IE) in F1AP UE context modification failure message. In an embodiment, the source DU sends a cell switch command/LTM command to the UE using a MAC CE.

In an embodiment, the gNB CU (108) and DU performs L3 mobility and LTM independently. The gNB CU (108) sends RRC Reconfiguration including RRCReconfiguration with sync for initiating L3 handover irrespective of cell switch triggered from DU. The gNB DU (110) sends cell switch command irrespective of whether L3 mobility is triggered.

In an embodiment, upon LTM completion (either receiving an indication from a target DU that LTM is completed after the UE (202) has accessed the target cell or receiving the RRC complete such as RRC Reconfiguration complete), the CU cancels on going L3 handover procedure. In an embodiment, this is specifically applicable when the CU receives the information from the DU (410) or the UE (202) about successful LTM completion after the UE performs LTM cell switch to a LTM candidate cell after a radio link failure without an explicit cell switch command. When there is an explicit cell switch command, CU may cancel the L3 Inter-gNB handover procedure before the completion indication, such as receiving a notification from the source DU about the initiation of LTM.

In an embodiment, upon receiving an indication from a target DU or UE (202) for LTM about the LTM completion (either receiving an indication from DU that LTM is completed after the UE (202) has accessed the target cell or receiving the RRC complete such as RRC Reconfiguration complete from the UE), CU cancels on going L3 handover procedure. In an embodiment, this is specifically applicable when the CU receives the information from the DU (410) or the UE (202) about successful LTM completion after the UE performs LTM cell switch to a LTM candidate cell after a radio link failure without an explicit cell switch command. When there is an explicit cell switch command, the CU may cancel the L3 Inter-gNB handover procedure before the completion indication, such as receiving a notification from the source DU about the initiation of the LTM.

In an embodiment, upon receiving an indication from a target DU or UE (202) about the LTM completion (either receiving an indication from DU that LTM is completed after the UE (202) has accessed the target cell or receiving the RRC complete such as RRC Reconfiguration complete from the UE), CU cancels on going L3 handover procedure. In an embodiment, this is specifically applicable when the CU receives the information from the DU (410) or the UE (202) about successful LTM completion after the UE performs LTM cell switch to a LTM candidate cell after a radio link failure without an explicit cell switch command. When there is an explicit cell switch command, the CU may cancel the L3 Inter-gNB handover procedure before the completion indication, such as receiving a notification from source DU about the initiation of LTM.

In an embodiment, upon receiving an indication from a target DU or UE (202) about the LTM completion (either receiving an indication from DU that LTM is completed after the UE (202) has accessed the target cell or receiving the RRC complete such as RRC Reconfiguration complete from the UE), the source gNB CU (108) in the intergNB handover as cancels on going L3 Inter-gNB handover procedure. In an embodiment, this is specifically applicable when the CU receives the information from the DU (410) or the UE (202) about successful LTM completion after the UE (202) performs the LTM cell switch to the LTM candidate cell after the radio link failure without the explicit cell switch command. When there is an explicit cell switch command, the CU may cancel the L3 Inter-gNB handover procedure before the completion indication, such as receiving a notification from the source DU about the initiation of the LTM.

In an embodiment, upon receiving an indication from a target DU or UE (202) about the LTM completion (either receiving an indication from DU that LTM is completed after the UE (202) has accessed the target cell or receiving the RRC complete such as RRC Reconfiguration complete from the UE), a source gNB CU (108) in the intergNB handover as in section cancels on going L3 Inter-gNB handover procedure by sending Xn handover cancel request message. In an embodiment, this is specifically applicable when the CU receives the information from the DU (410) or the UE (202) about successful LTM completion after the UE (202) performs the LTM cell switch to the LTM candidate cell after the radio link failure without an explicit cell switch command. When there is the explicit cell switch command, the CU may cancel the L3 Inter-gNB handover procedure before the completion indication, such as receiving a notification from the source DU about the initiation of the LTM.

In an embodiment, upon receiving a L3 measurement report containing the measurement results or upon deciding to perform L3 handover to a LTM candidate cell (a cell for which UE (202) has already LTM configuration), the gNB CU (108) instructs source gNB DU (204a) to perform cell switch command. The gNB DU (110) sends the cell switch command to the UE (202) instructing the UE (202) to perform LTM.

In an embodiment, the gNB CU (108) instructs gNB DU (110) to perform cell switch command. In an embodiment, CU includes an IE (for e.g. cellswitch) and an IE for identifying the candidate cell to which cell switch needs to be performed. In an embodiment, the IE for identifying the candidate cell is the candidate cell identifier. In an embodiment, the IE for identifying the candidate cell is physical cell identifier (PCI). In an embodiment, the IE for identifying the candidate cell is NR CGI. The gNB DU (110) sends the cell switch command to the UE (202) instructing the UE (202) to perform LTM.

In an embodiment, upon receiving a L3 measurement report containing the measurement results or upon deciding to perform L3 handover to a LTM candidate cell (a cell for which UE (202) has already LTM configuration), the gNB CU (108) sends a RRC message for handover (In NR, RRC Reconfiguration message including RRCReconfigurationwithsync). In an embodiment, upon receiving RRC message for handover (In NR, RRC Reconfiguration message including RRCReconfigurationwithsync), UE (202) executes the handover.

In an embodiment, upon receiving a L3 measurement report containing the measurement results or upon deciding to perform L3 handover to a LTM candidate cell (a cell for which UE (202) has already LTM configuration), the gNB CU (108) sends a RRC message for handover (In NR, RRC Reconfiguration message including RRCReconfigurationwithsync) including the cellgroupConfig received from the gNB DU (110) for the LTM candidate cell configuration.

In an embodiment, upon receiving a L3 measurement report containing the measurement results or upon deciding to perform L3 handover to a LTM candidate cell (a cell for which UE (202) has already LTM configuration), the gNB CU (108) sends a RRC message for handover (In NR, RRC Reconfiguration message including RRCReconfigurationwithsync) without performing a F1AP UE context setup procedure (i.e., step 203 and step 204 of FIG. 2 are skipped).

In an embodiment, upon receiving a L3 measurement report containing the measurement results or upon deciding to perform L3 handover to a LTM candidate cell (a cell for which UE (202) has already LTM configuration), the gNB CU (108) sends a RRC message for handover (In NR, RRC Reconfiguration message including RRCReconfigurationwithsync) by performing a F1AP UE context modification procedure (i.e., CU sends F1AP UE context modification request to DU in step 203 of FIG. 2 and DU sends F1AP UE context modification response to CU in step 204 of FIG. 2 (i.e., step 203 and step 204 of FIG. 2 are F1AP UE context modification request and response respectively instead of F1AP UE context setup request and response).

In an embodiment, the gNB CU (108) instructs the UE (202) to perform cell switch command and an information to identify the LTM candidate configuration in the above RRC message send for performing handover.

In an embodiment, the gNB CU (108) sends a RRC message for handover (In NR, RRC Reconfiguration message including RRCReconfigurationwithsync) to handover the UE (202) to a LTM candidate cell and includes the information to identify LTM candidate cell configuration (for e.g. LTM candidate cell identifier) in the handover message and instructs UE (202) to apply the LTM candidate cell configuration or part of the LTM candidate cell configuration identified by the information provided in ReconfigurationwithSync. The gNB CU (108) also may skip including the RRC IEs corresponding to the LTM candidate configuration or part of the LTM candidate configuration in the RRC message such as RRC Reconfiguration message including RRCReconfigurationwithsync. The UE (202) performs the L3 handover, applies the LTM candidate cell configuration or part of the LTM candidate cell configuration identified by the information provided in ReconfigurationwithSync (for e.g. LTM candidate cell identifier) in along with other information provided in the handover message. In an embodiment, the part of LTM candidate cell configuration as mentioned in the above embodiments includes one or more of CellGroupConfig, MeasConfig or RadioBearerConfig.

In an embodiment, the LTM candidate cell configuration may include the information elements as following Table 3.

TABLE 3
RRCReconfiguration ::= SEQUENCE {
rrc-TransactionIdentifier RRC-TransactionIdentifier,
criticalExtensions CHOICE {
rrcReconfiguration RRCReconfiguration-IEs,
criticalExtensionsFuture SEQUENCE { }
}
}
RRCReconfiguration-v1700-IEs ::= SEQUENCE {
otherConfig-v1700 OtherConfig-v1700 OPTIONAL, -- Need M
sl-L2RelayUE-Config-r17 SetupRelease { SL-L2RelayUE-Config-r17 } OPTIONAL,
-- Need M
sl-L2RemoteUE-Config-r17 SetupRelease { SL-L2RemoteUE-Config-r17 }
OPTIONAL, -- Need M
dedicatedPagingDelivery-r17 OCTET STRING (CONTAINING Paging)
OPTIONAL, -- Cond PagingRelay
needForGapNCSG-ConfigNR-r17 SetupRelease {NeedForGapNCSG-ConfigNR-r17}
OPTIONAL, -- Need M
needForGapNCSG-ConfigEUTRA-r17 SetupRelease
{NeedForGapNCSG-ConfigEUTRA-r17} OPTIONAL, -- Need M
musim-GapConfig-r17 SetupRelease {MUSIM-GapConfig-r17} OPTIONAL, -- Need
M
ul-GapFR2-Config-r17 SetupRelease { UL-GapFR2-Config-r17 } OPTIONAL, --
Need M
scg-State-r17 ENUMERATED { deactivated } OPTIONAL, -- Need N
appLayerMeasConfig-r17 AppLayerMeasConfig-r17 OPTIONAL, -- Need M
ue-TxTEG-RequestUL-TDOA-Config-r17 SetupRelease
{UE-TxTEG-RequestUL-TDOA-Config-r17} OPTIONAL, -- Need M
nonCriticalExtension RRCReconfiguration-v1800-IEs OPTIONAL
}
RRCReconfiguration-v1800-IEs ::= SEQUENCE {
applyLTMCandidateReconfigId candLTM-ReconfigId OPTIONAL, -- Need M
<other IEs>
nonCriticalExtension SEQUENCE { } OPTIONAL
}

Instead of candLTM-ReconfigId an alternate identifier such as NR CGI or PCI or any identifier which enables the UE (202) to uniquely identify the LTM configuration or part of LTM configuration as mentioned above may be send by the gNB (106a and 106b) and received by the UE (202).

In an embodiment, the UE (202) applies the LTM configuration identified by applyLTMCandidateReconfigId during RRCReconfiguration, for e.g. during Reconfiguration WithSync.

In an embodiment, the UE (202) applies one or more of CellGroupConfig, MeasConfig or RadioBearerConfig which is part of LTM configuration identified by applyLTMCandidateReconfigId during RRC Reconfiguration procedure handling, for e.g. during ReconfigurationWithSync when those part of LTM configuration is not received in the RRC Reconfiguration message. If one or more of one or more of CellGroupConfig, MeasConfig or RadioBearerConfig is present in the RRC message which includes applyLTMCandidateReconfigId, the UE (202) applies the one or more of CellGroupConfig, MeasConfig or RadioBearerConfig is present in the RRC message.

In an embodiment, the UE (202) applies the earliest HO triggered if the multiple HO procedures are configured (e.g. LTM, L3 handover). In an embodiment, the UE (202) performs LTM if both LTM and L3 handover are received simultaneously. In an embodiment, UE (202) performs L3 handover if both LTM and L3 handover are triggered simultaneously. In an embodiment, UE (202) receives a configuration from the network whether to perform L3 handover or LTM when both are triggered simultaneously. In an embodiment, the UE (202) performs L3 handover or LTM based on the internal configuration of the UE (202). In an embodiment, L3 handover is triggered when RRC Reconfiguration for handover (In NR, RRC Reconfiguration containing RRCReconfigurationwithSync is received) and LTM is triggered when a cell switch command is received.

In an embodiment, the UE (202) which is configured to perform LTM without lower layer reset (such as avoiding or partially performing MAC/RLC/PDCP reset) perform lower layer reset like MAC reset upon receiving RRC Reconfiguration for handover (In NR, RRC Reconfiguration containing RRCReconfigurationwithSync is received).

FIG. 5 illustrates various hardware components of the UE (202), according to the embodiments as disclosed herein.

In an embodiment, the UE (202) includes a processor (510), a communicator (520), a memory (530) and a handover co-existence controller (540). The processor (510) is coupled with the communicator (520), the memory (530) and the handover coexistence controller (540).

The handover co-existence controller (540) receives the L3 handover command to perform the L3 handover from the CU of the network apparatus (400). Further, the handover co-existence controller (540) receives the cell switch command to perform the LTM handover from the DU (410) of the network apparatus (400). Further, the handover co-existence controller (540) determines whether the L3 handover command to perform the L3 handover and the cell switch command to perform the LTM handover are received at same time or different time. In an embodiment, the handover co-existence controller (540) prioritizes the LTM handover over the L3 handover when both the L3 handover command to perform the L3 handover and the cell switch command to perform the LTM handover are received at the same time. In another embodiment, the handover co-existence controller (540) performs the LTM handover when the L3 handover command to perform the L3 handover is received before the cell switch command. In another embodiment, the handover co-existence controller (540) performs the L3 handover when the L3 handover command to perform the L3 handover is received before the cell switch command to perform the LTM handover.

In an embodiment, the handover co-existence controller (540) determines whether the L3 handover command is received earlier than the cell switch command. When the L3 handover command is received earlier than the cell switch command, the handover co-existence controller (540) performs the L3 handover command over the cell switch command. When the L3 handover command is received later than the cell switch command, the handover co-existence controller (540) performs the cell switch command over the L3 handover command. In an embodiment, the handover coexistence controller (540) receives the cell switch command and the L3 handover command in same transport block when the cell switch command and the L3 handover command are received at the same time.

The handover co-existence controller (540) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor (510) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (510) may include multiple cores and is configured to execute the instructions stored in the memory (530).

Further, the processor (510) is configured to execute instructions stored in the memory (530) and to perform various processes. The communicator (520) is configured for communicating internally between internal hardware components and with external devices via one or more networks. The memory (530) also stores instructions to be executed by the processor (510). The memory (530) may include nonvolatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (530) may, in some examples, be considered a non-transitory storage medium. The term “non-transitory” may indicate that the storage medium is not embodied in a carrier wave or a propagated signal. However, the term “non-transitory” should not be interpreted that the memory (530) is non-movable. In certain examples, a non-transitory storage medium may store data that can, over time, change (e.g., in Random Access Memory (RAM) or cache).

In an embodiment, the communicator (520) includes an electronic circuit specific to a standard that enables wired or wireless communication. The communicator (520) is configured to communicate internally between internal hardware components of the UE (202) and with external devices via one or more networks.

Although the FIG. 5 shows various hardware components of the UE (202) but it is to be understood that other embodiments are not limited thereon. In other embodiments, the UE (202) may include less or more number of components. Further, the labels or names of the components are used only for illustrative purpose and does not limit the scope of the invention. One or more components can be combined together to perform same or substantially similar function in the UE (202).

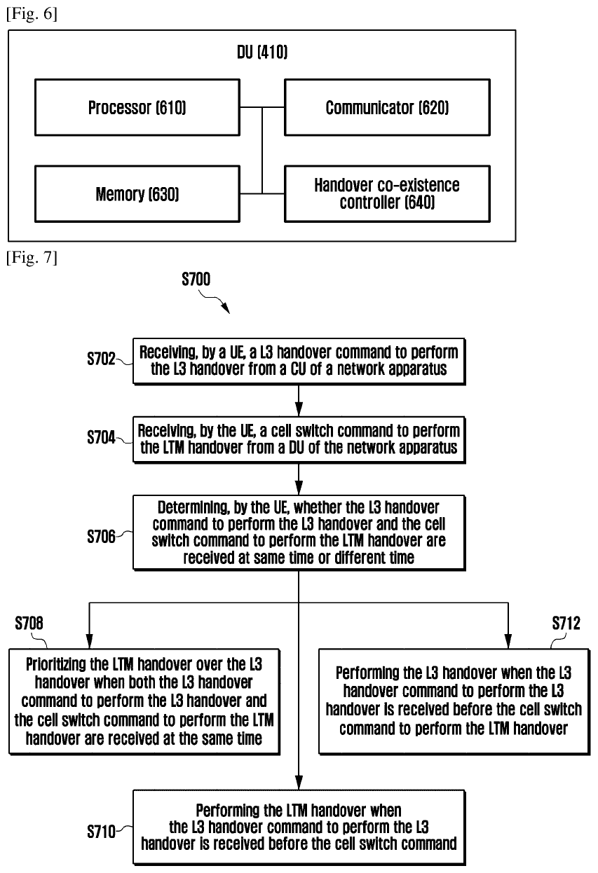

FIG. 6 illustrates various hardware components of the DU (410), according to the embodiments as disclosed herein.

In an embodiment, the DU (410) includes a processor (610), a communicator (620), a memory (630) and a handover co-existence controller (640). The processor (610) is coupled with the communicator (620), the memory (630) and the handover coexistence controller (640).

The handover co-existence controller (640) receives the UE context modification request from the CU (420) of the network apparatus (400) for the L3 handover for the UE (202). Further, the handover co-existence controller (640) determines whether the cell switch command for the UE (202) is triggered by the DU (410). In an embodiment, when the cell switch command is triggered for the UE (202) by the DU (410), the handover co-existence controller (640) transmits the UE context modification failure to the CU (420) of the network apparatus (400). The UE context modification failure is transmitted including the radio network layer cause IE in the F1AP UE context Modification Failure message. The radio network layer cause IE indicates that the lower layer mobility is already triggered. The DU (410) identifies that the F1AP UE context modification is for L3 handover when the F1AP UE context modification includes SpCellId IE. In another embodiment, when the cell switch command is not triggered for the UE (202) by the DU (410), the handover co-existence controller (640) stops the LTM related operation for the UE (202) by the DU (410). The LTM related operation can be, for example, but not limited to: triggering an aperiodic DCI, handling of LTM measurements, triggering LTM cell switch, and sending of the random access response for LTM completion, when the source DU and the target DU are the same.

The handover co-existence controller (640) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor (610) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (610) may include multiple cores and is configured to execute the instructions stored in the memory (120).

Further, the processor (610) is configured to execute instructions stored in the memory (630) and to perform various processes. The communicator (620) is configured for communicating internally between internal hardware components and with external devices via one or more networks. The memory (630) also stores instructions to be executed by the processor (610). The memory (630) may include nonvolatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (630) may, in some examples, be considered a non-transitory storage medium. The term “non-transitory” may indicate that the storage medium is not embodied in a carrier wave or a propagated signal. However, the term “non-transitory” should not be interpreted that the memory (630) is non-movable. In certain examples, a non-transitory storage medium may store data that can, over time, change (e.g., in Random Access Memory (RAM) or cache).

In an embodiment, the communicator (620) includes an electronic circuit specific to a standard that enables wired or wireless communication. The communicator (620) is configured to communicate internally between internal hardware components of the UE (202) and with external devices via one or more networks.

Although the FIG. 6 shows various hardware components of the DU (410) but it is to be understood that other embodiments are not limited thereon. In other embodiments, the DU (410) may include less or more number of components. Further, the labels or names of the components are used only for illustrative purpose and does not limit the scope of the invention. One or more components can be combined together to perform same or substantially similar function in the DU (410).

FIG. 7 illustrates a flow chart (S700) of a method, implemented by the UE (202), for handling the L3 handover and the LTM handover in the telecommunication network (1000), according to the embodiments disclosed herein. The operations (S702-S712) are handled by the handover co-existence controller (540).

At S702, the method includes receiving the L3 handover command to perform the L3 handover from the CU (420) of the network apparatus (400). At S704, the method includes receiving the cell switch command to perform the LTM handover from the DU (410) of the network apparatus (400). At S706, the method includes determining whether the L3 handover command to perform the L3 handover and the cell switch command to perform the LTM handover are received at same time or different time.

In an embodiment, at S708, the method includes prioritizing the LTM handover over the L3 handover when both the L3 handover command to perform the L3 handover and the cell switch command to perform the LTM handover are received at the same time. In another embodiment, At S710, the method includes performing the LTM handover when the L3 handover command to perform the L3 handover is received before the cell switch command. In another embodiment, At S712, the method includes performing the L3 handover when the L3 handover command to perform the L3 handover is received before the cell switch command to perform the LTM handover.

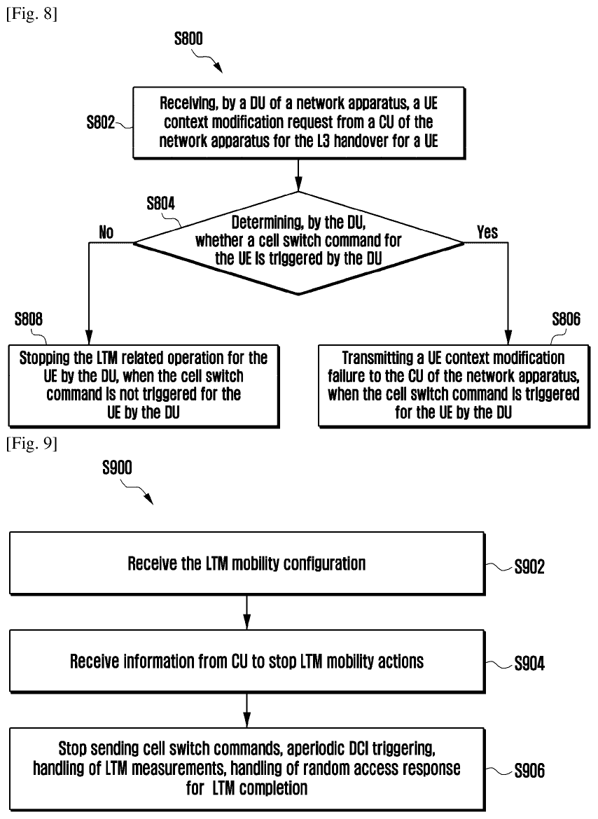

FIG. 8 illustrates a flow chart (S800) of a method, implemented by the DU (410), for handling the L3 handover and the LTM handover in the telecommunication network (1000), according to the embodiments disclosed herein. The operations (S802-S614) are handled by the handover co-existence controller (640).

At S802, the method includes receiving the UE context modification request from the CU (420) of the network apparatus (400) for the L3 handover for the UE (202). At S804, the method includes determining whether the cell switch command for the UE (202) is triggered by the DU (410). In an embodiment, at S806, the method includes transmitting the UE context modification failure to the CU (420) of the network apparatus (400), when the cell switch command is triggered for the UE (202) by the DU (410). In another embodiment, at S808, the method includes stopping the LTM related operation for the UE (202) by the DU (410), when the cell switch command is not triggered for the UE (202) by the DU (410).

FIG. 9 illustrates a flow chart (S900) of the LTM handling at the DU (410), according to the embodiments disclosed herein. The operations (S902-S906) are handled by the handover co-existence controller (640).

At S902, the method includes receiving the LTM mobility configuration. At S904, the method includes receiving the information from the CU (420) to stop the LTM mobility actions. At S906, the method includes stopping sending the cell switch commands, the aperiodic DCI triggering, handling of LTM measurements, and handling of random access response for the LTM completion.

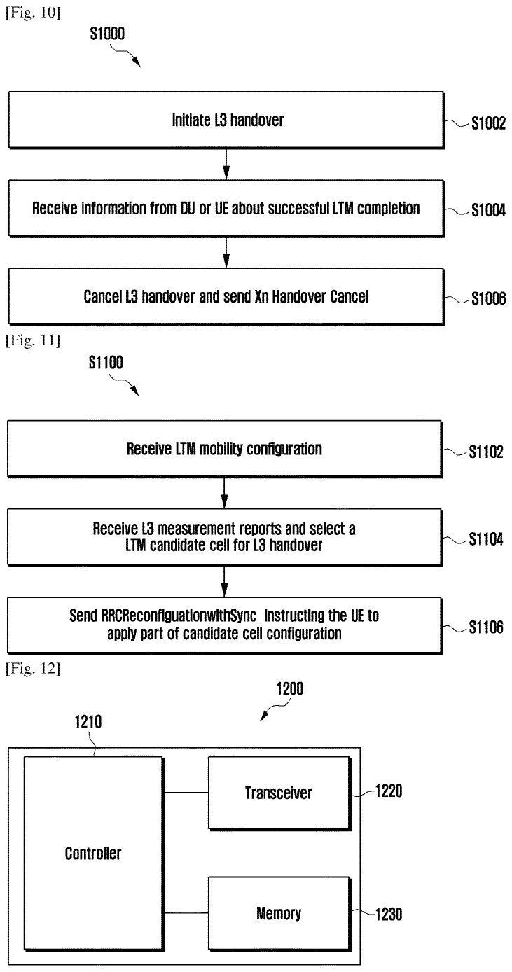

FIG. 10 illustrates a flow chart (S1000) of the LTM and L3 HO handling at the CU (420), according to the embodiments disclosed herein. Flow is specifically applicable when the CU receives the information from the DU (410) or the UE (202) about successful LTM completion after the UE (202) performs the LTM cell switch to the LTM candidate cell after the radio link failure without the explicit cell switch command. At S1002, the method includes initiating the L3 handover. At S1004, the method includes receiving the information from the DU (410) or the UE (202) about successful LTM completion. At S1006, the method includes cancelling the L3 handover and sending the Xn handover cancel.

FIG. 11 illustrates a flow chart (S1100) of the L3 HO applying part of candidate cell configuration, according to the embodiments disclosed herein. At S1102, the method includes receiving the LTM mobility configuration. At S1104, the method includes receiving the L3 measurement reports and selecting a LTM candidate cell for the L3 handover. At S1106, the method includes sending the RRCReconfiguationwithSync and instructing the UE (202) to apply part of candidate cell configuration.

The various actions, acts, blocks, steps, or the like in the flow charts (S700-S1100) may be performed in the order presented, in a different order or simultaneously. Further, in some embodiments, some of the actions, acts, blocks, steps, or the like may be omitted, added, modified, skipped, or the like without departing from the scope of the invention.

FIG. 12 illustrates a first network node according to embodiments of the present disclosure.

Referring to the FIG. 12, the first network node (1200) may include a controller (1210), a transceiver (1220) and a memory (1230). However, all of the illustrated components are not essential. The first network node (1200) may be implemented by more or less components than those illustrated in FIG. 12. In addition, the controller (1210) and the transceiver (1220) and the memory (1230) may be implemented as a single chip according to another embodiment.

The first network node (1200) may correspond to the gNB-DU described above. For example, the first network node (1200) may correspond to source the gNB-DU (110a-b, 204a) or the DU (410) described above.

The aforementioned components will now be described in detail.

The controller (1210) may include one or more processors or other processing devices that control the proposed function, process, and/or method. Operation of the first network node (1200) may be implemented by the controller (1210).

The transceiver (1220) may include an RF transmitter for up-converting and amplifying a transmitted signal, and an RF receiver for down-converting a frequency of a received signal. However, according to another embodiment, the transceiver (1220) may be implemented by more or less components than those illustrated in components.

The transceiver (1220) may be connected to the controller (1210) and transmit and/or receive a signal. The signal may include control information and data. In addition, the transceiver (1220) may receive the signal through a wireless channel and output the signal to the controller (1210). The transceiver (1220) may transmit a signal output from the controller (1210) through the wireless channel.

The memory (1230) may store the control information or the data included in a signal obtained by the first network node (1200). The memory (1230) may be connected to the controller (1210) and store at least one instruction or a protocol or a parameter for the proposed function, process, and/or method. The memory (1230) may include readonly memory (ROM) and/or random access memory (RAM) and/or hard disk and/or CD-ROM and/or DVD and/or other storage devices.

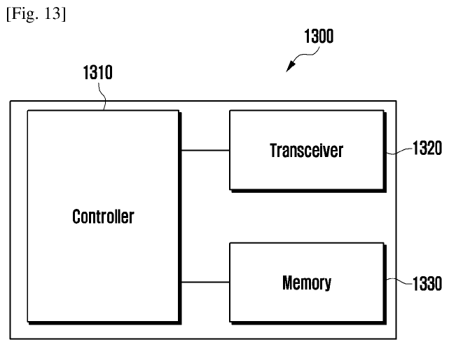

FIG. 13 illustrates a second network node according to embodiments of the present disclosure.

Referring to the FIG. 13, the second network node (1300) may include a controller (1310), a transceiver (1320) and a memory (1330). However, all of the illustrated components are not essential. The second network node (1300) may be implemented by more or less components than those illustrated in FIG. 13. In addition, the controller (1310) and the transceiver (1320) and the memory (1330) may be implemented as a single chip according to another embodiment.

The second network node (1300) may correspond to the gNB-DU described above. For example, the second network node (1300) may correspond to source the gNB-CU (108) or the DU (420) described above.

The aforementioned components will now be described in detail.

The controller (1310) may include one or more processors or other processing devices that control the proposed function, process, and/or method. Operation of the second network node (1300) may be implemented by the controller (1310).

The transceiver (1320) may include an RF transmitter for up-converting and amplifying a transmitted signal, and an RF receiver for down-converting a frequency of a received signal. However, according to another embodiment, the transceiver (1320) may be implemented by more or less components than those illustrated in components.

The transceiver (1320) may be connected to the controller (1310) and transmit and/or receive a signal. The signal may include control information and data. In addition, the transceiver (1320) may receive the signal through a wireless channel and output the signal to the controller (1310). The transceiver (1320) may transmit a signal output from the controller (1310) through the wireless channel.

The memory (1330) may store the control information or the data included in a signal obtained by the second network node (1300). The memory (1330) may be connected to the controller (1310) and store at least one instruction or a protocol or a parameter for the proposed function, process, and/or method. The memory (1330) may include readonly memory (ROM) and/or random access memory (RAM) and/or hard disk and/or CD-ROM and/or DVD and/or other storage devices.

The foregoing description of the specific embodiments will so fully reveal the general nature of the embodiments herein that others can, by applying current knowledge, readily modify or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1-15. (canceled)

16. A method performed by a first network node in a communication system, the method comprising:
receiving, from a second network node, a user equipment (UE) context modification request message related to a handover; and
in case that the first network node is not able to accept the UE context modification request message as a cell switch command has been triggered to a UE, transmitting, to the second network node, a UE context modification failure message.

17. The method of claim 16, wherein the UE context modification failure message includes information on a cause of failure indicating that the cell switch command has been triggered.

18. The method of claim 16, further comprising:
identifying that the UE accesses to a target cell for an L1/L2 triggered mobility (LTM); and
transmitting, to the second network node, information indicating that the LTM is completed.

19. The method of claim 16, wherein the first network node operates as a distributed unit (DU) of a next generation node B (gNB) and the second network node operates as a central unit (CU) of the gNB.

20. A method performed by a second network node in a communication system, the method comprising:
transmitting, to a first network node, a user equipment (UE) context modification request message related to a handover;
receiving, from the first network node, a UE context modification failure message; and
identifying, based on the UE context modification failure message, that the first network node is not able to accept the UE context modification request message as a cell switch command has been triggered to a UE.

21. The method of claim 20, wherein the UE context modification failure message includes information on a cause of failure indicating that the cell switch command has been triggered.

22. The method of claim 20, further comprising:
in case that the UE accesses to a target cell for an L1/L2 triggered mobility (LTM), receiving, from the first network node, information indicating that the LTM is completed.

23. The method of claim 20, wherein the first network node operates as a distributed unit (DU) of a next generation node B (gNB) and the second network node operates as a central unit (CU) of the gNB.

24. A first network node in a communication system, the first network node comprising:
a transceiver; and
a controller configured to:
receive, from a second network node via the transceiver, a user equipment (UE) context modification request message related to a handover, and
in case that the first network node is not able to accept the UE context modification request message as a cell switch command has been triggered to a UE, transmit, to the second network node via the transceiver, a UE context modification failure message.

25. The first network node of claim 24, wherein the UE context modification failure message includes information on a cause of failure indicating that the cell switch command has been triggered.

26. The first network node of claim 24, wherein the controller is further configured to:
identify that the UE accesses to a target cell for an L1/L2 triggered mobility (LTM), and
transmit, to the second network node via the transceiver, an access success message indicating that the LTM is completed.

27. The first network node of claim 24, wherein the first network node operates as a distributed unit (DU) of a next generation node B (gNB) and the second network node operates as a central unit (CU) of the gNB.

28. A second network node in a communication system, the second network node comprising:
a transceiver; and
a controller configured to:
transmit, to a first network node via the transceiver, a user equipment (UE) context modification request message related to a handover,
receive, from the first network node via the transceiver, a UE context modification failure message, and
identify, based on the UE context modification failure message, that the first network node is not able to accept the UE context modification request message as a cell switch command has been triggered to a UE.

29. The second network node of claim 28, wherein the UE context modification failure message includes information on a cause of failure indicating that the cell switch command has been triggered.

30. The second network node of claim 28, wherein the controller is further configured to:
in case that the UE accesses to a target cell for an L1/L2 triggered mobility (LTM), receive, from the first network node via the transceiver, information indicating that the LTM is completed.

31. The second network node of claim 28, wherein the first network node operates as a distributed unit (DU) of a next generation node B (gNB) and the second network node operates as a central unit (CU) of the gNB.
